(19) United States
(12) Patent Application Publication
(10) Pub. No.: US 2003/0186114 A1
(43) Pub. Date: Oct. 2, 2003

(54) Energy storage module and electrical apparatus

(76) Inventors: Guenter Lohr, Leinfelden-Echterdingen (DE); Stefan Roepke, Leinfelden (DE); Rainer Glauning, Aichtal-Groetzingen (DE)

Correspondence Address: STRIKER, STRIKER & STENBY, 103 East Neck Road, Huntington, NY, 11743, US

(21) Appl. No.: 10/396,142

(22) Filed: Mar. 25, 2003

(30) Foreign Application Priority Data
Mar. 30, 2002 (DE) 102 14 367.6

(51) Int. Cl. H01M 2/10

(52) U.S. Cl. 429/96; 429/99; 429/120

(57) ABSTRACT

An energy storage module for supplying current to an electrical apparatus, in particular, for an electrical hand-held machining tool, has at least one cell (10) for storing electrical energy and at least one cell support (12) for mounting the cell (10), whereby the cell support (12) is in contact with the cell (10). The cell support (12) is made at least partially of a heat-conductive material, in order to more effectively draw away heat from energy loss in the cell (10).

### BACKGROUND OF THE INVENTION

The present invention relates to an energy storage module for current supply of an electrical apparatus, in particular, for an electrical hand-held machining tool.

Modern hand-held machining tools, such as, for example, hand drills or accumulator worm or screw, often are supplied with current with accumulator packs, whereby the accumulator packs comprises multiple cells, which are electrically connected to one another and, for example, are held together by means of a plastic cover.

Upon operation of this type of accumulator pack, however, during both the charging and discharging stages, a substantial heat due to energy loss, which leads to an increase of the temperatures of the cells and, therewith, to a premature change of the cells.

In addition, such an accumulator pack, after the discharge process, has such a high temperature, based on the heat due to energy less, that the charging cannot be begun immediately. Furthermore, a charging apparatus provided for this purpose must first wait until the temperature of the accumulator pack is again lowered, whereby the charging process is delayed.

Moreover, the individual cells of such an accumulator pack, in operation, can have substantial temperature differences, since the head due to energy loss from the outer-lying cells is relative well lead off, while the cells in the center of the accumulator pack mostly form a localization of heat.

In addition, an accumulator pack from the company Makita is distributed, which during the charging process is cooled, in which a cool air flow is blown through the accumulator pack. Disadvantageously, however, for one is the face that the cooling does not take place during the discharging. For another, the interior of this known accumulator pack is contaminated by the cool air flow.

### SUMMARY OF THE INVENTION

The invention includes the general technical teachings, in which a cell support is provided with at least one cell with an energy storage module, the cell support being made of a heat-conductive material.

The cell support makes possible the drawing off of the heat due to energy loss in the interior of the energy storage module, so that this can be emitted on the outer side of the energy storage module, based on its very good heating conducting ability.

The cell support fixes the cell mechanically, in which the cell, for example, is wedged or fastened or adhered to the support. With an adhesion of the cell support with the cell, preferably a heat-conductive adhesive is used, in order to achieve a good heat transmission from the cell onto the cell support.

In a preferred embodiment of the invention, the cell support has a large heating capacitance, so that the heat due to energy loss transferred from the cell to the cell support only leads to a minimal temperature increase. This is advantageous, since the heating transfer from the cell onto the cell support is conveyed through a large temperature difference.

Preferably, the cell support comprises a material, whose heat conductivity and or specific heat capacitance is greater than that of air, plastic, paper, and/or the material of the cell.

In a preferred embodiment of the invention, the energy storage module has a plurality of cells for storing electrical energy, whereby the heat conductivity and/or the heat capacitance of the cell support is so large that the temperature difference between the individual cells in the charging operation and/or in the discharging operation is essentially smaller than the temperature difference of the cells relative to the surroundings.

Preferably, the heating conductivity and/or the heat capacitance of the cell support, therefore, is so large that the temperature difference between the individual cells in the charging operation and/or in the discharging operation is less than 5, 10, 15, 20, 30, 40 or 50 Kelvin.

Advantageously, the cell support of the inventive energy storage module is in contact with the cells collectively, such that the cell support can carry away the heat from energy loss from all of the cells. The connection between the cell support and the individual cells is preferably planar, in order to achieve the smallest possible heating transfer resistance as possible.

In one variation of the invention, the cell support is made of multiple parts, which is particularly advantageous with large accumulator packs with a plurality of cells. The individual parts of the cell support, hereby, have respectively at least one heat conducting surface, on which the parts of the cell support are connected with one another in a flat or planar fashion. This planar connection between the individual parts of the cell support advantageously makes possible a good heat transfer.

For further improvement of conveying away of the heat, in a preferred embodiment of the present invention, at least one cooling body is provided, which passively gives off the heat or actively blows it from a blower.

Preferably, the cooling body, in this connection, is arranged in a housing opening or projects through this outwardly from the energy storage module. In this manner, advantageously, a direct heat bridge from the interior of the energy storage module outwardly is formed, so that the heat from energy loss in the interior of the energy storage module can be effectively drawn out. The cooling body can be connected with the cell support in the interior of the energy storage module or directly with a cell, in order to cool with priority the temperature-critical interior of the energy storage module.

In addition, an electrical terminal contact is preferably also arranged in the housing opening, via which the energy storage module can be connected with an electrical apparatus or a charging apparatus. The common arrangement of the terminal contact and the cooling body in the housing opening offers the advantage of a simple electrical and thermal contact in an electrical apparatus or in a charging apparatus.

Further, the energy storage module preferably has a mechanical guide, by means of which the energy storage module can be mechanically fixed in an electrical apparatus or in a charging apparatus. The guide, for example can comprise cam grooves, which are arranged on both sides of the housing opening, so that the energy storage module can be inserted in a receiving compartment of the electrical apparatus or the charging apparatus.

The term “energy storage module”, as used in the frame of the present invention, is not limited to an accumulator pack. Furthermore, the invention is also realizable with non-rechargeable battery packs as well as with other types of energy storage, which produce heat from energy loss in operation.

In addition, the invention includes an electrical apparatus with an inventive energy storage module, whereby the apparatus can operate as an accumulator-driven, hand-held machining tool or a charging apparatus, for example.

The cooling of the inventive energy storage module, in this connection can be supported by a blower.

### BRIEF DESCRIPTION OF THE DRAWINGS

Further advantages are provided in the following description of the drawing. In the drawing, one embodiment of the invention is illustrated. The drawing, the description, and the claims contain a multitude of features in combination. The practitioner also is to recognize individual features and to combine them in further, practical combinations.

FIG. 1 shows an accumulator pack for a hand-held machining tool according to the present invention.

### DETAILED DESCRIPTION OF THE PREFERRED EMBODIMENTS

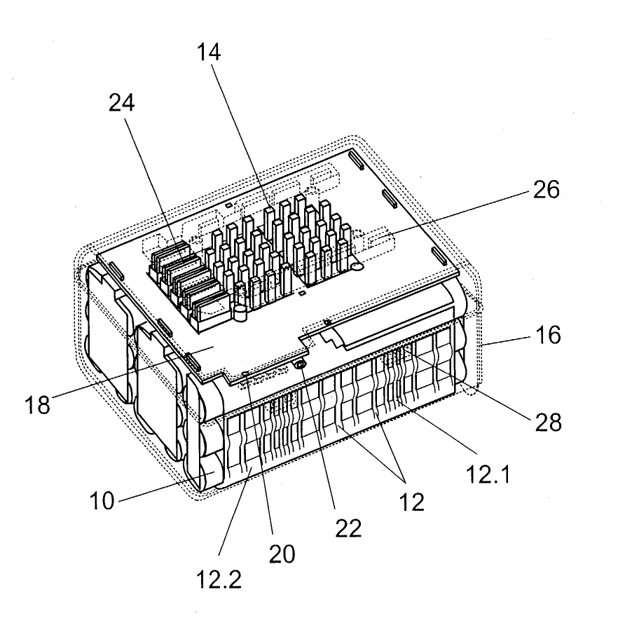

The perspective, partially cut-away illustration in FIG. 1 shows an accumulator pack for a hand-held machining tool, such as, for example, a hand drill or an accumulator worm or screw driver.

For storage of electrical energy, the accumulator pack has a total of 30 accumulator cells 10, which have a generally cylindrical shape. In the accumulator pack, respectively, three cells are arranged over one another, five cells are arranged adjacent one another, and two cells are arranged behind one another, whereby a compact form of the accumulator pack is achieved.

The individual accumulator cells 10 hereby are arranged for mechanical fixing in a honeycomb-shaped or grid-shaped cell support 12 and are adhered with the cell support 12 by means of an adhesive.

In addition to the mechanical fixing of the accumulator cells 10, the cell support 12, in the frame of the invention also serves for cooling of the accumulator cells 10.

The adhesion of the individual accumulator cells 10 with the cell support 12 takes place by means of a heat-conductive adhesive, so that the heat transfer resistance between the accumulator cells 10 and the cell support 12 is as small as possible.

In addition, the cell support 12 is made of aluminum, which, as a material, has a large heat conductivity and also a large, specific heat capacitance.

The good heat conductivity of the cell support 12 offers the advantage that the heat from energy loss produced by the interior accumulator cells 10 is lead away outwardly, whereby an overheating of the accumulator pack in the interior is avoided.

The large heat capacitance of the cell support 12 additionally is advantageous, since the cell support 12 therefore can receive a relative large amount of the heat from energy loss from the accumulator cells 10, without being heated. As a result, this heat uptake by the cell support 12 leads then to a lowering of the temperature of the accumulator cells 10.

On the top side of the cell support 12, numerous cooling bodies 14 are formed, which, likewise, are made of aluminum and have a large upper surface, in order to effectively dispense the heat from energy loss taken up from the accumulator cells 10 to the surrounding air. Upon discharging of the accumulator pack in an electrical apparatus, as well as upon charging in a charging apparatus, the cooling bodies 14 are flowed again with ambient air by means of a blower, in order to improve the heat dispersion by convection.

The cell support 12 hereby comprises two parts 12.1, 12.2, which are arranged behind one another in the longitudinal direction of the accumulator cells 10, whereby each part 12.1 or 12.1 of the cell support 12 or 15, absorbs accumulator cells 10. On their front sides, the two parts 12.1, 12.1 of the cell support 12, respectively, have flat front surfaces, which, in a mounted state, lie flat on one another and are connected to one another by means of screws, whereby a good heat transfer between the two parts 12.1, 12.1 of the cell support 12 is achieved.

In addition, the accumulator pack has a housing 16 made of plastic, whereby on the upper side of the housing 16, a housing opening is arranged, through which the cooling bodies 14 project outwardly. This offers the advantage that the cooling bodies 14 are accessible on the outer side of the accumulator pack and can be cooled well.

Moreover, the accumulator pack has a circuit board, which is attached to the top side of the cell support 12 within the housing the housing and which supports a light diode 20, a switch 22, as well as electrical terminal contacts 24. The light diode 20, the switch 22, and the electrical terminal contacts 24 are hereby arranged within the housing opening and likewise, are accessible from outside.

In addition, two guide tracks 26 are arranged on the outer side of the housing 16 on both sides of the housing opening, via which the accumulator pack can be inserted into a receiving compartment of an electrical apparatus or a charging apparatus, whereby the guide tracks 26 of the accumulator pack engaged in correspondingly adapted guide tracks in the receiving compartment. In the inserted state, the accumulator pack is then fixed in the receiving compartment of the electrical apparatus or charging apparatus by means of snap hooks 28.

It will be understood that each of the elements described above, or two or more together, may also find a useful application in other types of constructions differing from the types described above.

While the invention has been illustrated and described herein as an energy storage module and electrical apparatus, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. Energy storage module for supplying current of an electrical apparatus, in particular, for an electrical hand-held machining tool, with at least one cell (10) for storage of electrical energy, at least one cell support (12) for mounting of the at least one cell (10), whereby the cell support (12) is in contact with the at least one cell (10), characterized in that the cell support (12) is made at least partially from a heat-conductive material.

2. Energy storage module according to claim 1, characterized in that the material of the cell support (12) has a heat conductivity and/or a specific heat capacitance that is greater than that of air, plastic, paper and/or a material of the at least one cell (10).

3. Energy storage module according to claim 1, characterized in that a plurality of cells (10) for storing electrical energy are provided, whereby the heat conductivity and/or the heat capacitance of the cell support (12) is so large that a temperature difference between individual cells (10) in a charging operation and/or a discharge operation is essentially smaller than a temperature difference of the cells (10) relative to the surrounding environment.

4. Energy storage module according to claim 3, characterized in that the heat conductivity and/or the heat capacitance of the cell support (12) is so large that the temperature difference between the individual cells (10) in the charging operation and/or in the discharge operation is smaller than 5, 10, 15, 20, 30, 40 or 50 Kelvin.

5. Energy storage module according to claim 1, characterized in that the cell support (12) is made of a plurality of parts (12.1, 12.2) with, respectively, at least one heat-conducting surface, whereby the parts (12.1, 12.2) of the cell support (12) are connected to one another on the at least one heat-conducting surface.

6. Energy storage module according to claim 1, characterized in that at least one cooling body (14) is mounted or formed on the cell support (12).

7. Energy storage module according to claim 6, characterized by a housing (16) with a housing opening, whereby the at least one cooling body (14) and/or an electrical terminal contact (24) is arranged in the housing opening or projects outwardly through the housing opening.

8. Energy storage module according to claim 7, characterized by a mechanical guide (26), wherein said guide (26) is arranged on both sides of the housing opening.

9. Energy storage module according to claim 1, characterized in that the at least one cell (10) is adhered with the cell support (12) by means of a heat-conductive adhesive.

10. Electrical apparatus with an energy storage module according to claim 1.

11. Electrical apparatus according to claim 10, characterized in that a blower is provided for blowing on at least one cooling body (14).
